(19) United States
(12) Patent Application Publication
(10) Pub. No.: US 2006/0013744 A1
(43) Pub. Date: Jan. 19, 2006

(54) Container comprising a reference gas, a set of reference fluids, a cassette comprising the reference fluids, and an apparatus comprising the reference fluids

(75) Inventors: Michael Tokeskov Mikkelsen, Virum (DK); Peter Frischauf, Brondby (DK); Anne Rosengaard Jorgensen, Horsholm (DK)

Correspondence Address: MORGAN LEWIS & BOCKIUS LLP, 1111 PENNSYLVANIA AVENUE NW, WASHINGTON, DC, 20004, US

(73) Assignee: Radiometer Medical ApS

(21) Appl. No.: 11/179,476

(22) Filed: Jul. 13, 2005

Related U.S. Application Data
(60) Provisional application No. 60/616,850, filed on Oct. 8, 2004.

(30) Foreign Application Priority Data
Jul. 13, 2004 (DK) PA 2004/01105

(51) Int. Cl. B01L 3/00

(52) U.S. Cl. 422/102

(57) ABSTRACT

A flexible container for a reference gas for use in performing calibration or quality control of an apparatus for determining a gas parameter in a physiological liquid, such as blood. The flexible container is adapted to hold the reference gas at or close to ambient pressure, so that no pressure conversion is required. The flexible container has a continuous inner surface and is not penetrated until use. The inner surface has no or a low reactivity with the reference gas, which may comprise oxygen or carbon dioxide. A set of reference fluids and a cassette holding the set may be used in the apparatus.

This application claims the benefit of U.S. Provisional Application No. 60/616,850, filed on Oct.8, 2004, which is hereby incorporated by reference.

### FIELD OF THE INVENTION

The present invention relates to the provision of a reference gas for use in, e.g., an apparatus for determining a gas parameter in a physiological fluid.

### BACKGROUND OF THE INVENTION

Normally, reference gas components may be provided in zero headspace fluid containers in which the reference gas components are dissolved in a liquid phase. No gas phase is present in this type of container (a zero headspace container) in order to minimize pressure and temperature dependency of the concentration of the gas in the liquid. However, for some gases, such as oxygen, the remainder of the constituents of the liquid may convert or react with the oxygen so that its concentration in the liquid still is not sufficiently constant to retain a certain reference level for an extended period of time.

Containers for zero headspace reference liquids may be seen in EP-A-1 243 336, WO99/40430, US-A-2003/0019306, U.S. Pat. Nos. 6,632,675, 6,136,607, 6,016,683, 4,384,925, as well as in U.S. Pat. No. 4,116,336.

Another manner of providing the reference gas has been to provide it in pressurized containers, which provide problems both due to the large pressures therein and due to security aspects during transportation. Further, the costs of producing containers suitable for a pressurized reference gas are high and thus require a recirculation system. Also, the high pressures require the inclusion of decompression valves in the apparatuses in which the containers are installed in order to bring the gas to a pressure, which may be handled by the apparatus.

### SUMMARY OF THE INVENTION

The present invention relates to a novel type of reference gas container.

In a first aspect, the invention relates to a container comprising a reference gas for an apparatus for determining a parameter of a physiological fluid, the container comprising a container wall formed of a flexible material, the container being at least substantially gas tight and having an unbroken inner surface, which has a low or no reactivity with the reference gas, wherein the pressure of the reference gas is at least substantially equal to ambient pressure.

In the present context, the container is at least substantially gas tight when the total diffusion from the container or into the container of one or more gases of the surroundings and/or in the container during a period of time from filling the gas in the container and until the gas is to be used does not result in a change exceeding a certain allowable maximum change of the initial partial pressure of the parameter in the reference gas. The maximum change is determined by the demands to the precision and/or accuracy of the measurements to be performed.

In the clinical field, the demands to a reference gas are in general so heavy that a maximum change of no more than ±2(vol/vol)%, preferably ±1%, and more preferred ±0.5% of the initial partial pressure of the parameter in the reference gas is allowable. The period of time is preferably at least one month, more preferred at least one year, and yet more preferred at least 3 years. The most common gas components towards which the wall should be gas tight are primarily oxygen, nitrogen, carbon dioxide and any reference gas component or diluent contained in the container.

The advantage of a reference gas container providing a stable reference gas for an extended period of time is that it may be stored and transported when it is convenient and does not need to be controlled strictly by the user.

The present reference gas is a gas which is fully in its gas phase when at room temperature and ambient pressure. The reference gas has a predetermined partial pressure of the parameter. The container may also comprise other gas components, such as other reference gases at predetermined partial pressures or any gas components suitable as diluents, such as nitrogen, carbon dioxide, argon or helium. Naturally the gases present in the container must be inert to (have low or no reactivity with) each other.

In the present context, “at least substantially equal to ambient pressure” means at the most two times the ambient pressure, and normally not below ambient pressure. Normally, the pressure is close to ambient pressure, but a pressure up to two times the ambient pressure may exist, especially after penetration of the container.

Preferably, there is only a gas phase present in the container. If any fluid or solid is present in the container, it is inert to (has a low or no reactivity with) the reference gas in order to ensure that no or as little as possible of the reference gas is converted or reacted with.

In the present context, the material of the container wall is flexible when by deformation or flexing of the wall the volume of the container may be reduced with a volume corresponding closely (such as within 10%) to a volume of reference gas removed from the container. Naturally, the container may have an initial internal pressure above the ambient pressure, whereby the reduction in inner volume may not take place when removing the first volume of gas from the container.

The inner surface is unbroken when it is a continuous surface which has not been broken by a probe or access device such as a valve. Thus, no access is possible to the gas through the inner surface when the surface is unbroken. This is in contrast to the provision of valves penetrating the inner surface. Economic valves suitable as disposable valves are not completely gas tight and normally are an important source of gas diffusion/leaks both through the valve itself and possibly also through the sealing around the valve.

A material has a low or no reactivity with a gas when an amount of less than 2% (vol/vol), preferably ±1%, and more preferred ±0.5%, of the gas is converted or reacted with during a time interval of 1 month, more preferred at least one year, and yet more preferred at least 3 years. The choice of materials with no or low reactivity to gases depends on the gas or gases to be held in the container.

Examples of a physiological fluid may be whole blood, blood plasma, serum, cerebrospinal fluids, spit and urine.

The gas parameter of the physiological fluid is any gas parameter, which may be present in the physiological fluid, notably oxygen or carbon dioxide. Other gas parameters may be carbon monoxide or anaesthesia gases, such as isoflurane, sevoflurane, desflurane or N₂O.

The container comprising a reference gas according to the invention may be used in an apparatus for determining a gas parameter of a physiological fluid. Such apparatus comprises a sensor sensitive to the gas parameter of the physiological fluid. In the apparatus the reference gas of the container may be used in combination with other reference materials such as other reference gases or reference liquids.

The reference gas may be used for calibration or quality control of a sensor sensitive to the gas parameter.

A calibration of the sensor is to be understood as an experimental determination of the correspondence between the sensor responses and predetermined parameter values of a reference material. Usually, said correspondence is found by obtaining sensor responses to one or more reference materials having predetermined parameter values and determining the correspondence between those.

The correspondence determined in the above calibration is then used when a parameter in a physiological fluid is to be determined. First, a sensor response to the physiological fluid is obtained. Then, the sensor response is converted into a measured parameter value by using the correspondence determined.

The conversion may be effected by programmed controller comprising an algorithm to provide a measured parameter value. The algorithm may be adjusted in each calibration step.

Any number of reference materials may be used in the calibration step. The number of reference materials which are required to obtain a reliable calibration of a sensor depends on the nature of the sensor and on the demands for accuracy and/or precision. It is thus preferred to use reference materials representing one to five different parameter levels in the calibration step. Two or three different levels are more preferred in many instances, since this for most sensors provides sufficiently reliable results and at the same time limits the number of different reference materials. For some sensors, e.g. many biosensors, it is however required to use four or five reference materials to obtain sufficiently reliable results.

It may be sufficient to initially calibrate the sensor once using more than one reference material. Any subsequent calibrations may then be performed using only one reference material and is simply used to correct the previously determined correspondence between sensor responses and predetermined parameter values.

However, many sensors need to be calibrated regularly and often using reference materials representing at least two parameter levels. A calibration using reference materials representing more than two parameter levels may in some cases provide a more reliable calibration. For instance, carbon dioxide sensors are often calibrated in two points, whereas oxygen sensors are often calibrated in between one and three points.

A quality control of the sensor is to be understood as the experimental verification that the sensor measurements are accurate and/or precise. Usually such verification is performed by determining whether a measured parameter value of a reference material is within an acceptance range thereof. The measured parameter value of the reference material is obtained by converting the sensor response into the measured parameter value using a calibration correspondence as described above. It is then determined whether the measured parameter value is within the acceptance range of the reference material.

The acceptance range is generally centered around a predetermined parameter value. The limits of the range depend, e.g., on sensor variation, on the variation when determining the predetermined parameter value of the reference materials for both the quality control and the calibration and/or demands for accuracy and precision.

Preferably, the container is adapted to provide access to the reference gas only upon penetration of the container wall, preferably the flexible material. This may be obtained by providing a container with no valve or other means penetrating or providing access through the wall. Thus, the only manner of gaining access to the gas inside the container is by penetration of the wall.

However, the container may comprise an access device, such as a septum, connector or valve attached to the inside and/or outside of the container wall but not penetrating the inner surface of the container, for facilitating penetration of the flexible material. The flexible material may be made of any material providing adequate flexibility, non-reactivity and gas tightness, such as polyolefines, for example a polyethylene (PE), polypropylene (PP) or polyethylene terephtalate (PETP), an oriented polyamide (OPA, nylon), or a polyamide (PA) depending on the period of time in which the concentration of the reference gas parameter in the container is to be kept constant.

In a preferred embodiment, the flexible material is a laminate having an inner layer, forming at least part of the unbroken inner surface of the container, and an outer layer. The layers may be made of any materials, which in combination provide adequate non-reactivity, flexibility and gas tightness. The inner layer may, e.g., be made of any of the materials mentioned above for the flexible material.

When the flexible material is a laminate, it is preferred that none of the layers providing gas tightness have been penetrated by a probe or access device, such as a valve.

Prior to penetration of the unbroken inner surface, there is no or only limited access for the gas to the outer layer, which may therefore fulfil other purposes than non-reactivity with the reference gas, such as providing further gas tightness and/or providing mechanical strength to the laminate. This strength may be useful both for mechanically protecting the inner layer, for facilitating penetration of the laminate prior to use of the gas, for forming a basis for labelling etc. The outer layer may, e.g., be a layer of polyvinyl chloride (PVC), polyvinylidene chloride (PVdC), ethylenevinylalcohol (EVOH), aluminium, gold, a silicium based polymer (SiOx), an OPA, PETP, a PP or a PE.

Preferably, suitable adhesives, such as a retort adhesive or the like are used to attach the layers of the laminate to each other. Retort adhesives are especially good at bonding to aluminium and at withstanding high temperatures during high temperature curing, disinfecting, and/or welding.

When e.g. welding the laminate, this will normally be performed by positioning two parts of the laminate with the welding surfaces against each other. Preferably, the welding surfaces are different parts of the inner surface. The welding will provide an unbroken inner surface, so that the gas is not in direct contact with the outer or any intermediate layer of the laminate. However, the welding surfaces may also be one part of the inner surface and another part of the outer surface. The inner surface being thus welded to the outer surface of another part of the laminate will also provide an unbroken inner surface. Since in this case an edge of the laminate ends inside the container that edge must not present any materials that convert or react with the components of the reference gas.

In the weldings the only material preventing diffusion of gas is normally the combined welded layer. Thus, a small diffusion of gas into or out of the container may be seen in the weldings (depending on the gas tightness of the material(s) of the welding layers and of the dimensions of the welding layers). If needed the weldings may be sealed on the outside of the container by materials providing further gas tightness, such as aluminium or silicium based polymer.

Naturally, the laminate may have any number of layers and any number of layers may be interposed between the inner layer and the outer layer. Thus, the laminate may further comprise one or more intermediate layers interposed between the inner layer and the outer layer. Accordingly, a third layer may be provided between the inner layer and the outer layer. In this case, if the outer layer primarily provides mechanical strength to the laminate, and the inner layer primarily provides the “reaction resistance” toward the gas as well as good welding properties, then the third layer may be used for providing gas tightness to the laminate or for improving any gas tightness of the inner and/or outer layer. The properties of the individual layers except for the required reaction resistance of the inner layer may be distributed differently on the individual layers.

This or these intermediate layers may be made of any of the materials mentioned for the inner and the outer layers depending on which properties the additional layer(s) is/are to confer or improve.

In a preferred embodiment, the inner layer is made of a polypropylene or a polyethylene, the intermediate layer is made of aluminium and the outer layer is made of polyethylene terephthalate.

In that embodiment, it may be desired that the laminate comprises a further layer made of an oriented polyamide (OPA; nylon), which is interposed between the inner layer and the aluminium layer.

One manner of providing the flexible material is to provide an inner layer having a low reactivity with the reference gas, and whereon another layer is formed by metallization, for example with aluminium in order to provide a gas tight layer. This metallized layer may provide the gas tightness desired and may in turn be covered by a layer providing mechanical resistance.

In one embodiment, the entire container is made of the same flexible material, the inner surface of the flexible material forming the inner surface of the container. Such flexible material is preferably a laminate. This makes manufacture of the container easy and economical.

Preferably, the reference gas comprises oxygen at a predetermined partial pressure. Oxygen is particularly difficult to handle, due to a number of materials converting or reacting with oxygen, which are used in conventional reference liquids suitable for the present type of apparatus for determining a parameter in a physiological fluid. Preferably, then, neither the inner surface of the container nor the other reference gas components or other substances in the container should convert or absorb oxygen. Substances, that do convert oxygen include, e.g., many organic materials, such as dyes, lactate, glucose and other sugars and organic buffers, as well as many metals.

Using this type of container, it is possible to obtain a reference gas comprising oxygen at a predetermined partial pressure of at least 200 mm Hg. Such high oxygen partial pressures have, to the knowledge of the inventors, not been seen before in flexible containers for this use, particularly not in multi-analyte reference fluids.

In addition or alternatively, the reference gas may preferably comprise carbon dioxide at a predetermined partial pressure.

In another embodiment, the container comprises an at least substantially rigid wall and one or more walls made of the flexible material, the inner surface of the rigid wall forming part of the inner surface of the container. The advantage of the rigid wall is seen when handling, labelling, mounting, penetrating etc. the container. In those situations, the more rigid wall may make it easier to handle the container.

The more rigid wall may be made of OPA, PE and/or PP, the rigidity being obtained by providing a thicker layer of the material. Alternatively the more rigid wall may be provided as a laminate. In such case the laminate may comprise layers made of the same materials as mentioned above for the laminate of the flexible material. The rigidity may be obtained by providing a thicker layer of one or more of the layers already present in the laminate or by providing a more rigid layer interposed between the inner and the outer layers. The more rigid layer may, e.g., be made of OPA, PE and/or PP. The more rigid layer may be encapsulated in the other layers such that the laminate of the more rigid wall does not comprise the more rigid layer in the welding areas.

Another embodiment is one wherein the rigidity is provided by fixing, such as by gluing or welding, a more rigid sheet, plate or disc onto the flexible material.

A second aspect of the invention relates to a set of reference fluids for performing calibration and/or quality control of an apparatus for determining a parameter of a physiological fluid, the set comprising:
a first container as described according to the first aspect, and
a second container comprising a reference liquid.

The set may further comprise one or more additional first and/or second containers. Normally, at least some of these additional containers will comprise one or more other levels of the same gas parameters. Calibrations and quality controls normally use different levels of the same parameters in order to achieve more reliable calibrations or quality controls.

Preferably, the reference liquid and the reference gas each has a partial pressure of the same parameter. Thus, the reference liquid and reference gas each has a predetermined partial pressure of a substance or constituent present in the physiological fluid, such as oxygen, carbon dioxide, or the like. If the gas is oxygen, preferably the higher level is present in the gas container and the lower in the liquid container.

It may be desired that the reference liquid in the second container comprises at least substantially no gas phase. The second container then holds the reference liquid with zero headspace in order to make it less sensitive to variations in the ambient pressure and temperature.

In order for the set to be useful also for calibrating sensors for other parameters, preferably the second container further comprises predetermined reference levels of other selected parameters of the physiological fluid. In this manner, the reference liquid may be used for performing calibration or quality control of an apparatus adapted to determine a number of parameters of the physiological fluid. Such an apparatus may comprise a plurality of sensors, each being sensitive to one of the parameters of the physiological fluid.

Naturally, the gas container(s) may also comprise more than a single reference gas in order for it to be used for calibrating more than a single gas parameter.

The set of reference fluids are preferably multi-analyte reference fluids representing levels of multiple parameters, for example:
pH, concentrations of electrolytes, such as Li⁺, Na⁺, K⁺, Ca²⁺, Mg²⁺, Cl⁻, HCO₃⁻ and NH₃ (NH₄⁺); concentrations of other dissolved gases, notably oxygen and carbon dioxide (conventionally reported in the form of partial pressures, e.g. pO₂, pCO₂); hematocrit (Hct); concentration of haemoglobin and haemoglobin derivatives, such as oxyhaemoglobin, deoxyhaemoglobin, methaemoglobin, carboxyhaemoglobin, sulfhaemoglobin and fetal haemoglobin; concentrations of metabolic factors, such as glucose, creatinine, creatine, urea (BUN), uric acid, lactic acid, pyruvic acid, ascorbic acid, phosphate, protein, bilirubin, cholesterol, triglycerides, phenylalanine and tyrosine; concentrations of enzymes, such as lactic acid dehydrogenase (LDH), lipase, amylase, choline esterase, alkaline phosphatase, acid phosphatase, alanine amino transferase (ALAT), aspartate amino transferase (ASAT) and creatinine kinase (CK); concentrations of ligands, such as antibodies and nucleotide fragments; and concentrations of biomarkers, such as brain natriuretic peptide (BNP), troponin, myoglobin, human chorionic gonadotropin, and C-reactive protein.

Preferably, the set of reference fluids represent levels of between four and twenty parameters.

A third aspect of the invention relates to a cassette for use in an apparatus for determining a parameter of a physiological fluid, the cassette comprising a first container according to the first aspect, the cassette further comprising a flexible waste container adapted to receive waste from the apparatus. If the apparatus produces any gaseous waste, the waste container is usually equipped with a device, such as a vent, for venting any such gaseous waste from the apparatus.

Normally, cassettes of this type have been provided with only flexible liquid containers. The present aspect has the advantage that as time passes and reference gas from the flexible reference gas container is used, space is liberated in the cassette for the waste container to take up samples and external quality control (QC) liquids having been measured in the apparatus. As the gas is held close to ambient pressure in the container, this effect will be seen already at or close to the beginning of the withdrawing of gas from the gas container. This provides for efficient use of the space present in the cassette.

It may be preferred that the present cassette instead of holding a reference gas container only, actually comprises a set according to the second aspect in order to obtain the advantages of not only the container, but the full set.

Thus, in a preferred embodiment, the cassette further comprises a second flexible container holding a reference liquid. The flexible waste container is preferably adapted to hold a volume exceeding the volume of reference liquid initially present in the cassette, since the liquid is to be used by the apparatus and thereafter will be discarded as waste together with the samples measured in the apparatus. Thus, the flexible waste container may be empty when starting to use reference liquid and gas, and as the reference liquid and gas are used, room is made available to the waste container which takes up at least part of that room when it receives used reference liquid and samples. Normally, the amount of sample to be held in the waste container in addition to the amount of reference liquid may be in the interval of 20% to 200%, such as in the interval of 30%-50% of the amount of reference liquid. Thus, the presence of the flexible gas container in the cassette makes room for both the used reference liquid(s) and the sample as well as for external QC liquids used.

A fourth aspect relates to an apparatus for determining a gas parameter of a physiological fluid, the apparatus comprising:
a first container according to the first aspect comprising a predetermined partial pressure of the parameter,
a reference gas inlet,
a sensor sensitive to the parameter,
a conducting device for conducting the reference gas to the sensor, and
a programmable device for controlling the functioning of the apparatus.

In the present context, the reference gas inlet is adapted to receive reference gas from the first container and make this gas available for the conducting device. The reference gas has a partial pressure of the parameter to which the sensor is sensitive.

The apparatus may comprise further sensors sensitive to other parameters of the physiological fluid, such as the parameters mentioned above for the set of reference fluids.

As used here, the term “sensor” denotes any kind of device of which some part, in the present context called the sensing part, is capable either of selectively interacting with the chemical species of interest, thereby producing a well-defined and measurable response which is a function of the desired characteristic of that chemical species, the desired characteristic thus being derivable therefrom; or of responding to a bulk property of a fluid, the response not being selective with respect to any specific chemical species, but being a function of the total concentration of one or more chemical species in the liquid, the desired characteristic thus being derivable therefrom.

Relevant types of sensors are those adapted to determine any of the previously mentioned parameters, for example potentiometric sensors, amperometric sensors, optical sensors etc.

The sensor may be of any design. Accordingly, both miniaturized, planar sensors, and conventional sensors are suitably calibrated and quality controlled using the container comprising a reference gas according to the invention.

Naturally, the apparatus could, alternatively to the first container alone, comprise a set of reference fluids according to the second aspect or a cassette according to the third aspect. Thus, in addition to the first container, the apparatus may further comprise a second container comprising reference liquid.

The apparatus may further comprise a conducting device for receiving a sample of the physiological fluid, of which the parameter is to be determined, and conducting it to the sensor, and a device for conducting the sample from the sensor to the waste container after measurement.

When the gas is provided at a pressure close to or equal to the ambient pressure, a forcing of the gas may be required in order to bring the gas to the sensor. Thus, the conducting device may comprise means for pumping or sucking (forcing) the gas from the container to the sensor, e.g. a pump.

The pumping/sucking means could be adapted to also pump/suck liquid from the second container to the sensor. Thus, when the conducting device is adapted to receive and conduct all reference gas and reference liquid at a pressure at least substantially equal to the ambient pressure, the same conducting means and forcing means may be used for both gas and liquid and no pressure conversion is required for the gas.

Preferably, the conducting device comprises a selecting device adapted to direct gas or fluid from a first one of the first and second containers to the sensor and to subsequently direct gas or fluid from another of the first and second containers to the sensor, the conducting device conducting the gas and liquid from the selecting device to the sensor using a single flow channel. In this connection, the single flow channel may physically be divided into more channels, as long as both gas and liquid use the same flow channels. It is in particular an advantage if liquids, which it is desired to keep separate, are conducted/transported with intermediate segments of gas. The segments of gas may, e.g., be reference gas from the first container or, alternatively, ambient air.

Normally, the flow channels are rinsed with a rinse solution in order to remove any deposits in the flow channels or on the sensor surfaces. The cleaning components may be added to a reference liquid, such liquid being thus both a reference liquid and a rinse solution. In order to improve the rinsing action small segments of ambient air may be introduced into the stream of rinse solution. In this manner, liquid segments are separated by gas segments. This creates turbulent conditions, which improve the rinsing action and also reduce carry over from the first liquid volume to the next liquid volume.

In one embodiment of the apparatus in which the apparatus includes a carbon dioxide sensor small segments of the reference gas are introduced between segments of rinse solution instead of ambient air. Also in this case, the gas segments introduced between the rinse solution segments provide for turbulent flow and thus better cleaning action. The advantage of using reference gas instead of ambient air is that the reference gas may have a partial pressure of carbon dioxide so as to keep the carbon dioxide sensor from drifting during this rinsing procedure. This is an advantage since normal carbon dioxide sensors require presence of carbon dioxide all the time or most of the time in order not to drift, and the reconditioning of such sensors after rinsing without carbon dioxide is time consuming. The apparatus could accordingly further comprise means for controlling the selecting device so as to first direct a reference liquid from a second container, subsequently direct a reference gas from a first container, and lastly direct a reference liquid from a second container.

In general, the sensor is preferably adapted to provide a sensor response relating to a presence or a concentration of the parameter in the reference gas, the reference liquid, and/or the physiological fluid. The apparatus could then further comprise means for receiving the sensor response and performing a calibration or a quality control of the apparatus on the basis of the response.

A fifth aspect of the invention relates to a method of operating an apparatus according to the fourth aspect, the method comprising:
a) firstly penetrating the first container(s) in order to gain access to the reference gas therein, and then
b) using the conducting device to conduct reference gas from the first container to the sensor,
c) providing a sensor response relating to a presence or a concentration of the parameter in the gas, and
d) on the basis of the sensor response, calibrating the sensor or performing a quality control of the sensor.

In a preferred embodiment:
an initial step is performed of firstly providing a set according to the second aspect of the invention,
step b) comprises sequentially providing, under a pressure at least substantially equal to ambient pressure of the apparatus, gas and liquid from the first and second containers to the sensor,
step c) comprises providing a sensor response relating to a presence or a concentration of the parameter in the gas or liquid of the first and second containers, and
step d) comprises performing the calibration or the quality control on the basis of the sensor responses.

A sixth aspect of the invention relates to a method of performing a calibration and/or quality control of a sensor that determines a gas parameter of a physiological fluid, the method comprising:
penetrating a first container according to the first aspect of the invention containing a reference gas comprising a predetermined partial pressure of the parameter;
providing the reference gas to the sensor;
using at least a response from the sensor to the reference gas to calibrate and/or perform quality control of the sensor.

The method of the sixth aspect of the invention is, thus, preferably performed on an apparatus according to the fourth aspect of the invention. The step of providing the reference gas to the sensor may be performed by conducting the reference gas via the conducting device of the apparatus.

The first container may be provided in a cassette, and in this case the method may further comprise providing a reference liquid from a second container to the sensor, the reference liquid comprising a predetermined partial pressure of the same parameter, and the second container also being provided in the cassette. In this case the step of using may comprise using at least responses from the sensor to the reference gas and the reference liquid to calibrate and/or perform quality control of the sensor. Thus, in this embodiment the method may be performed on an apparatus comprising a cassette according to the third aspect of the invention.

Alternatively or additionally, the method may further comprise providing a further reference gas from a further reference gas container to the sensor, the further reference gas comprising a predetermined partial pressure of the same parameter, and the further reference gas container also being provided in the cassette. In this case the step of using may comprise using at least responses from the sensor to the reference gases to calibrate and/or perform quality control of the sensor. In this embodiment at least two reference gas containers are used.

Alternatively or additionally, the method may further comprise providing a reference liquid from a second container to the sensor, the reference liquid comprising a predetermined partial pressure of the same parameter, and the second container also being provided in the cassette. In this case the step of using may comprise using at least responses from the sensor to the reference gases and the reference liquid to calibrate and/or perform quality control of the sensor.

It is to be understood that both the foregoing general description and the following detailed description are exemplary and explanatory.

### BRIEF DESCRIPTION OF THE DRAWINGS

In the following, preferred embodiments of the invention is described with reference to the drawings, wherein:

FIG. 1 illustrates the relevant parts of an apparatus for determining a parameter of a physiological fluid before using any of the reference gases and liquids,

FIG. 2 illustrates the apparatus of FIG. 1 after a period of use,

FIGS. 3A and 3B illustrate a first embodiment of a gas container made of a laminate, and

FIG. 4 illustrates another embodiment of a gas container.

### DETAILED DESCRIPTION

Reference will now be made in detail to preferred embodiments of the present invention, examples of which are illustrated in the accompanying drawings.

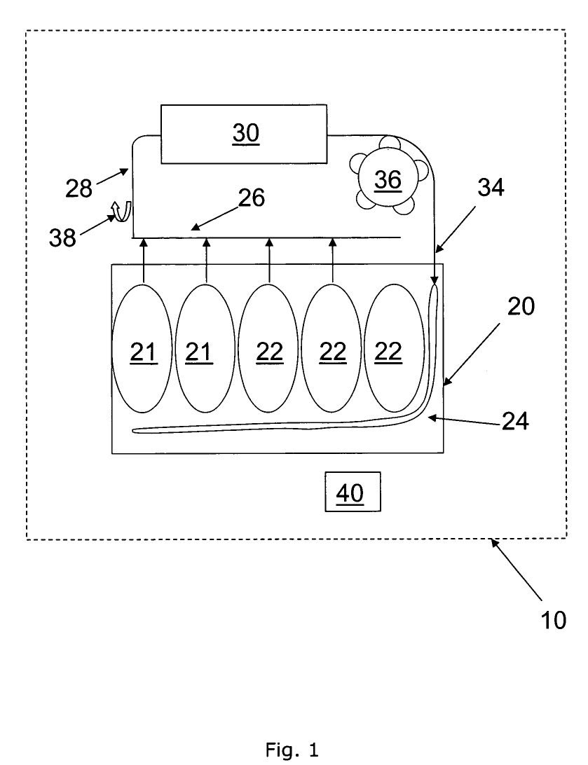

In FIG. 1, a system 10 is illustrated for determining a parameter of a physiological fluid. The system 10 comprises a cassette 20 comprising a number of first flexible containers 21 comprising gas and a number of second flexible containers 22 comprising liquid for use in performing calibration or quality control of a sensor 30, and preferably a plurality of sensors. These sensors may include sensors for measuring pH, pCO₂, pO₂, cK⁺, cNa⁺, cCa₂⁺, cCl⁺cGlu, cLac or tHb. The first flexible containers 21 each comprises a reference gas at a pressure which is at least substantially equal to ambient pressure. The various containers 21 may comprise different reference gases, e.g. one container 21 comprising oxygen and another container 21 comprising carbon dioxide. Alternatively, the containers 21 may comprise the same reference gas in different concentrations. Further, the containers 21 may comprise several gases in each container 21, the concentration of the gases varying from container 21 to container 21.

Since the containers 21 and 22 are flexible, they will adapt to changes of their contents and only take up as much space as their contents require.

A pump 36 is used for drawing gas/liquid from a selected one of the containers 21, 22 through a selection system 26, which may comprise valves or the like (not illustrated), and further on through a first conducting tube 28, the sensor 30, a second conducting tube 34, and finally into a waste container 24 also present in the cassette 20.

It is interesting to note that the same pump 36 may be used for conducting gas as well as liquid through the system 10 and, thereby, past the sensor 30. In this manner, the pump 36 is able to define, e.g., a velocity of flow of both gas and liquid. In addition, as the gas containers 21 are flexible, and as the pressure of the reference gas is at least substantially equal to ambient pressure, the pump 36 (or other means of forcibly moving the gas) may actually be required in order to move the gas from the container 21 to the sensor 30.

One advantage of having the gas in the containers 21 at ambient pressure is the fact that this gas may now be introduced as separating gas segments between neighbouring quantities of liquid or sample in the tubes 28 and 34 as well as in the sensor 30. These gas segments may be used for separating these liquids and prevent or reduce carry over therebetween as well as to create turbulent conditions in the rinse solution to better remove any deposits. This may be provided simply by operating the pump 36 and selection system 26 accordingly.

Also, in FIG. 1, inlet 38 is provided for receiving a sample of the physiological fluid. The inlet 38 may be shaped so as to receive a capillary tube or the Luer of a syringe or a vented tip cap. The sample may be received in the following manner. An inlet probe is inserted into a sampler (not shown) in order to aspirate the sample directly from the inner space of the sampler. The sample is drawn to the sensor 30, and after measurement it is directed to the waste container 24 using the pump 36. Alternatively, a separate pump may be used for that purpose.

The inlet 38 may, furthermore, be used for introducing a quality control sample into the system 10 in case it is desired to perform a quality control of the sensor 30.

In FIG. 1, the waste container 24 is empty and the containers 21, 22 are full. Thus, FIG. 1 illustrates the system 10 after the cassette 20 with the containers 21, 22 has been positioned in the system 10, but before any reference gas, reference liquid or samples of physiological fluid have been transported to the sensor 30.

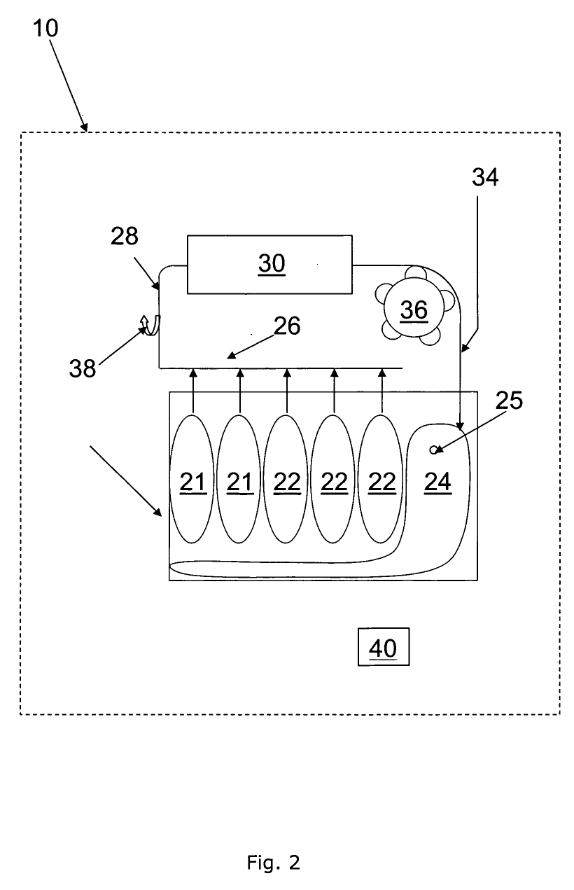

FIG. 2 illustrates the system 10 at a point in time later on, where part of the gas/liquid in the containers 21, 22 have been used and subsequently transported to the waste container 24. In addition, a number of samples of physiological fluid may have been measured and transported to the waste container 24.

The waste container 24, in FIG. 2, comprises a vent 25 which allows gas to escape from the container 24. This makes it possible for the container 24 to also be able to receive both the used gas/liquid and the samples measured without overfilling the cassette 20. In one embodiment the flexible containers 21, 22 and 24 may completely fill out the cassette 20 when the containers 21, 22 are full and the waste container 24 is empty, as illustrated in FIG. 1. In that situation, the addition of samples of physiological fluid would not be possible, if the used gas was also to be held by the waste container 24. Thus, venting the gas used through vent 25 makes room for the samples in the waste container 24.

In FIGS. 1 and 2, two first containers 21 and three second containers 22 are shown. It could, however, also be contemplated that one of the first containers 21 is substituted by a connection between the selection system 26 and the ambient air, thereby providing the possibility of introducing gas segments of ambient air into the system 10, e.g. in order to use ambient air as separating gas segments.

The relevant aspects of calibration or quality control of the sensor 30 will now be described.

In general, it is desired to have calibration/QC samples having both a high and a low content of a given substance or parameter to be determined by the sensor 30. In addition, a content between the high and low contents may be used for, e.g., QC of the instrument. The actual calibration or quality control based on these parameters is well known.

Presently, at least the higher oxygen-concentration is provided in a gas container 21, possibly together with carbon dioxide and an inert diluent, such as nitrogen. Actually, in the present embodiment the higher and the lower oxygen concentrations are present in gas containers 21. In addition, a concentration between these concentrations is present in a liquid container 22. Preferably, liquid containers 22 are zero-headspace containers.

The other gas containers 21 and liquid containers 22 comprise similar high, medium and low concentrations or levels of other substances or parameters to be determined in the physiological fluid by the sensor 30.

Preferably, for determining blood parameters, the containers may comprise:

| Parameter/ | Liquid | Liquid | Liquid | Gas | | Gas | |
|---|---|---|---|---|---|---|---|
| substance | container | container | container | container 1 | | container 2 | |
| pH | 7.2 | 6.8 | 7.6 | | | | |
| pCO2 (mmHg) | 30 | 70 | 10 | 40 | (5.7%) | 80 | (11.3%) |
| PO2 (mmHg) | 180 | ˜100 | ˜100 | 41 | (5.73%) | 275 | (38.7%) |
| cK+ (mmol/L) | 4.0 | 7.0 | 2.0 | | | | |
| cNa+ (mmol/L) | 140 | 90 | 180 | | | | |
| cCa2+ (mmol/L) | 0.8 | 1.65 | 0.4 | | | | |
| cCl+ (mmol/L) | 100 | 65 | 130 | | | | |
| cGlu (mmol/L) | 0 | 7 | 15 | | | | |
| cLac (mmol/L) | 0 | 4 | 8 | | | | |
| tHb (mmol/L) | 0 | 6 | 12 | | | | |

Then, the gases/liquids from the containers 21, 22 are sequentially, in a predetermined order, provided to the sensor 30 which, in the normal manner, determines the contents of the substances/parameters and is then calibrated or quality controlled.

In FIGS. 1 and 2 is illustrated a programmable device 40 which may be a CPU or other controlling means which is able to control the selection system 26, the pump 36, and the sensor 30 as well as performing the calculations or determinations required in order to quality control or calibrate the sensor 30—as well as to use the results thereof in order to determine the parameters of physiological fluids. The programmable device 40 is, of course, operatively connected to at least the selection system 26, the pump 36, and the sensor 30, e.g. by means of electrical wires or other suitable connections for carrying control signals between the programmable device 40 and the controlled parts 26, 36, 30 of the system 10. For the sake of clarity of FIGS. 1 and 2 these connections are, however, not shown in the Figures.

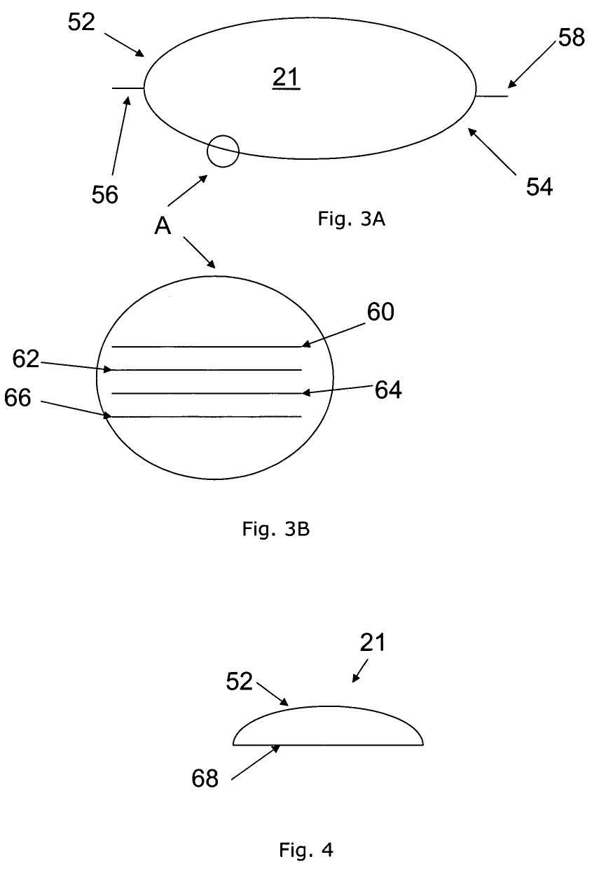

The present flexible container 21 is illustrated in FIG. 3A, where two sheets 52 and 54 of laminate are welded together at welding seams 56 and 58. The container walls are not penetrated prior to use, and access to the contents of the container 21 is achieved by penetrating sheet 52 or sheet 54.

Alternatively, a single sheet 52 of laminate may be welded at a side thereof in order to form a tube, which is subsequently closed at one end, filled with the gas and finally sealed at the other end thereof. Such a container 21 will then have three welding seams.

In FIG. 3B, a cross section A of the laminate sheet 54 of the container 21 of FIG. 3A is shown. It is seen that the laminate comprises four layers, 60, 62, 64, and 66, where the inner layer 60 faces the interior of the container 21 and thus makes up the inner surface of the sheet 54.

The function of the inner layer 60 is both to have no or only a little reactivity with a gas in the container 21 as well as of providing a good and sealing welding seam when two layers of the laminate are welded together to form the container 21. In fact, it is contemplated that even though good weldings may be obtained, the major gas diffusion from the container 21 takes place through the welding seams 56, 58. Thus, these welding seams 56, 58 should have a good diffusion resistance toward the gas in that this part of the container 21 does not have the outer layer 66 to take care of that functionality.

The function of the outer layer 66 is mainly to protect the other layers from bends, pinholes in the aluminium layer, undesired penetration/breaking, and to form a suitable basis for printing. Also, it may provide a desired rigidity to the laminate in order to facilitate penetration. In addition, the rigidity may be desired in other operations where the container 21 is to be handled. Another functionality of the outer layer 66 may be to provide an external diffusion barrier in order to prevent the ambient gas/air from reacting with the inner or any intermediate layers, such as aluminium.

The layers 62 and 64 may also function to assist the layers 60 and 66 in their purposes. Also, these layers may be diffusion barriers preventing escape or diffusion of gas over the laminate.

In order to ensure that the layers 60, 62, 64, 66 of the laminate stay attached to each other also during transportation and penetration before use, an adhesive, such as retort glue is preferably used for laminating the layers 60, 62, 64, 66.

It should be noted that the laminate may comprise fewer layers. The presently preferred gas container 21, adapted to hold a gas with a high oxygen content, has:
the inner layer 60 being PP70, which is a polypropylene layer of 70 μm thickness,
a diffusion barrier layer 62 of Aluminium, such as with a thickness of 7 or 9 μm, and
the outer layer 66 of PETP 12, which is a layer of polyethylene terephtalate with a thickness of 12 μm, for protecting the other layers and for providing a better basis for labelling, increasing the rigidity of the laminate etc.

The fourth layer 64 (or 62 as these layers may be interchanged, depending on the purpose of the layer) may be provided between the inner 60 and outer 66 layers in order to provide a better diffusion resistance. This additional diffusion barrier layer 64 may be OPA 15, which is an (bi-axially) oriented polyamide with a thickness of 15 μm.

Other laminates, such as laminates where the outer layer 66 is OPA, 12 or 15 may be used. The inner layer 60 may be PE, such as with a thickness of 50 or 100 μm, or PP, such as with a thickness of 100 μm.

Diffusion barriers may be Aluminium, such as with a thickness of 7, 9, 12, or 18 μm, or PVdC (Saran).

FIG. 4 illustrates an alternative embodiment of a container 21 comprising a laminate 52 providing the flexible function of the container 21 and having a rigid base member 68 which is attached, such as welded, to the laminate 52. Optionally, another, more rigid laminate may be used for providing the functionality of the laminate 52 and the base member 68. Naturally, the base member 68 has a surface facing the interior of the container 21 which has no or only a little reactivity with the gas in question. This base member 68 may make handling of and printing on the container 21 easier. Also, penetration of the container 21 in order to gain access to the gas therein may be performed at the base member 68. In fact, the use of this rigidity may render the cassette 20 shown in FIGS. 1 and 2 unnecessary.

It will be apparent to those skilled in the art that various modifications and variations can be made in the method and system of the present invention without departing from the spirit or scope of the invention. Thus, it is intended that the present invention cover the modifications and variations of this invention provided they come within the scope of the appended claims and their equivalents.

1. A container comprising a reference gas for an apparatus for determining a gas parameter of a physiological fluid, the container comprising:
a container wall formed of a flexible material, the container being at least substantially gas tight and having an unbroken inner surface, which has a low or no reactivity with the reference gas, wherein the pressure of the reference gas is at least substantially equal to ambient pressure.

2. The container according to claim 1, wherein the container is adapted to provide access to the reference gas by penetration of the flexible material.

3. The container according to claim 2, wherein the container further comprises an access device for facilitating penetration of the flexible material.

4. The container according to claim 1, wherein the flexible material is a laminate having an inner layer and an outer layer, the inner layer forming at least part of the unbroken inner surface of the container.

5. The container according to claim 4, wherein the laminate further comprises one or more intermediate layers interposed between the inner layer and the outer layer.

6. The container according to claim 5, wherein the inner layer is made of a polypropylene or a polyethylene, at least one of the intermediate layers is made of aluminium, and the outer layer is made of polyethylene terephthalate.

7. The container according to claim 6, wherein the laminate comprises a further layer made of an oriented polyamide and interposed between the inner layer and the aluminium layer.

8. The container according to claim 1, wherein the entire container is made of the same flexible material, the inner surface of the flexible material forming the inner surface of the container.

9. The container according to claim 1, wherein the reference gas comprises oxygen at a predetermined partial pressure.

10. The container according to claim 9, wherein the reference gas comprises oxygen at a partial pressure of at least 200 mm Hg.

11. The container according to claim 1, wherein the reference gas comprises carbon dioxide at a predetermined partial pressure.

12. The container according to claim 1, wherein the container further comprises an at least substantially rigid wall and one or more walls made of the flexible material, the inner surface of the rigid wall forming part of the inner surface of the container.

13. A set of reference fluids for performing calibration and/or quality control of an apparatus for determining a gas parameter of a physiological fluid, the set comprising:
a first container containing a reference gas for the apparatus for determining a gas parameter of a physiological fluid, the first container having a container wall formed of a flexible material and being at least substantially gas tight and having an unbroken inner surface, which has a low or no reactivity with the reference gas, wherein the pressure of the reference gas is at least substantially equal to ambient pressure; and
a second container comprising a reference liquid.

14. The set according to claim 13, wherein each of the reference liquid and the reference gas has a partial pressure of the same parameter.

15. The set according to claim 13, wherein at least one of the fluids is a multi-analyte reference fluid representing levels of multiple other parameters.

16. The set according to any of claim 13, wherein the set comprises first containers representing two different levels of the parameter and second containers representing three different levels of one or more other parameters.

17. A cassette for use in an apparatus for determining a gas parameter of a physiological fluid, the cassette comprising:
a first container containing a reference gas for the apparatus for determining a gas parameter of a physiological fluid, the first container having a container wall formed of a flexible material and being at least substantially gas tight and having an unbroken inner surface, which has a low or no reactivity with the reference gas, wherein the pressure of the reference gas is at least substantially equal to ambient pressure; and
a flexible waste container adapted to receive waste from the apparatus.

18. The cassette according to claim 17, further comprising a second container comprising a reference liquid, wherein the reference gas and the reference liquid form a set of reference fluids for performing calibration and/or quality control of an apparatus for determining a gas parameter of a physiological fluid.

19. An apparatus for determining a gas parameter of a physiological fluid, the apparatus comprising:
a first container containing a reference gas comprising a predetermined partial pressure of the parameter, the first container having a container wall formed of a flexible material and being at least substantially gas tight and having an unbroken inner surface, which has a low or no reactivity with the reference gas, wherein the pressure of the reference gas is at least substantially equal to ambient pressure,
a reference gas inlet,
a sensor sensitive to the parameter,
a conducting device for conducting the reference gas to the sensor, and
a programmable device for controlling the functioning of the apparatus.

20. The apparatus according to claim 19, further comprising a second container comprising a reference liquid, wherein the reference gas and the reference liquid form a set of reference fluids for performing calibration and/or quality control of the apparatus for determining a gas parameter of a physiological fluid.

21. The apparatus according to claim 20, wherein each of the reference liquid and the reference gas has a partial pressure of the same parameter.

22. The apparatus according to claim 20, wherein at least one of the reference gas and the reference liquid is a multi-analyte reference fluid representing levels of multiple other parameters.

23. The apparatus according to claim 19, wherein the first container forms part of a cassette for use in determining a gas parameter of a physiological fluid, the cassette further comprising:
a flexible waste container adapted to receive waste from the sensor.

24. The apparatus according to claim 19, wherein the first container forms part of a cassette for use in determining a gas parameter of a physiological fluid, the cassette further comprising a flexible waste container adapted to receive waste from the sensor, and a second container comprising a reference liquid, wherein the reference gas and the reference liquid form a set of reference fluids for performing calibration and/or quality control of the apparatus for determining a gas parameter of a physiological fluid.

25. A method of performing a calibration and/or quality control of a sensor that determines a gas parameter of a physiological fluid, the method comprising:
penetrating a first container containing a reference gas comprising a predetermined partial pressure of the parameter, the first container having a container wall formed of a flexible material, the first container being at least substantially gas tight and having an unbroken inner surface, which has a low or no reactivity with the reference gas, wherein the pressure of the reference gas is at least substantially equal to ambient pressure;
providing the reference gas to the sensor;
using at least a response from the sensor to the reference gas to calibrate and/or perform quality control of the sensor.

26. The method according to claim 25, wherein the first container is provided in a cassette, the method further comprising:
providing a reference liquid from a second container to the sensor, the reference liquid comprising a predetermined partial pressure of the same parameter, and the second container also being provided in the cassette; and
wherein said step of using comprises using at least responses from the sensor to the reference gas and the reference liquid to calibrate and/or perform quality control of the sensor.

27. The method according to claim 25, wherein the first container is provided in a cassette, the method further comprising:
providing a further reference gas from a further reference gas container to the sensor, the further reference gas comprising a predetermined partial pressure of the same parameter, and the further reference gas container also being provided in the cassette,
wherein said step of using comprises using at least responses from the sensor to the reference gases to calibrate and/or perform quality control of the sensor.

28. The method according to any of claims 25, wherein the first container is provided in a cassette, the method further comprising:
providing a reference liquid from a second container to the sensor, the reference liquid comprising a predetermined partial pressure of the same parameter, and the second container also being provided in the cassette; and
wherein said step of using comprises using at least responses from the sensor to the reference gases and the reference liquid to calibrate and/or perform quality control of the sensor.
